(19) United States
(12) Patent Application Publication
(10) Pub. No.: US 2012/0020074 A1
(43) Pub. Date: Jan. 26, 2012

(54) SURFACE LIGHT SOURCE DEVICE HAVING SEPARATED COLOR MIXING MEMBER AND EFFECTIVE MEMBER

(76) Inventors: Naoya Sone, Yokohama-shi (JP); Takahiro Ito, Tokyo (JP); Nobuyuki Kobayashi, Sagamihara-shi (JP); Koichi Hanasaki, Kanagawa (JP); Tokihiko Shinomiya, Osaka (JP)

(21) Appl. No.: 13/260,322

(22) PCT Filed: Mar. 19, 2010
(86) PCT No.: PCT/JP2010/054819

§ 371 Date: Sep. 25, 2011

(30) Foreign Application Priority Data
Mar. 25, 2009 (JP) 2009-073460

(51) Int. Cl. F21V 9/00; F21V 7/00

(52) U.S. Cl. 362/231

(57) ABSTRACT

A color-mixing section R1 is constructed by allocating to each light-adjusting area one or more LEDs 311, . . . as primary light sources and color-mixing elements R1(411), . . . for guiding primary light from the LED 311, . . . to color-mix or homogenize the brightness. An available element R2 for receiving secondary light from the color-mixing elements to emit light covers the entire color-mixing elements. The LEDs 311, . . . and the color-mixing elements R1(411), . . . are not superposed onto each other.

### TECHNICAL FIELD

The present invention relates to a surface light source apparatus used as a planar illumination apparatus such as a backlight of a liquid crystal display unit, a transparent-type advertising display backlight, a tracer light box unit, a Schaukasten (Roentgen light box) illumination unit, or a ceiling, lamp.

### BACKGROUND TECHNOLOGY

Recently, in order to improve contrast and reduce power consumption, a local dimming function for light-adjusting areas is added to a surface light source apparatus of a liquid crystal television set or the like. A surface light source apparatus having such a local dimming function may use a linear cold cathode fluorescent lamp, a linear hot cathode fluorescent lamp, as a surface light source apparatus (see: Patent Literatures 1, 2 and 3).

On the other hand, one or more point-like light sources are used as light sources of a Hg-free surface light source apparatus from an environmental point of view. For example, one type of point like light source is a white light emitting diode (LED) formed by coating fluorescent substance onto a blue EEL), and the other type of point-like light source is a set of a red LED, a blue LED and a green LED for adequately color-mixing red, blue and green monochromatic lights to obtain white-light.

Therefore, Stanley Electric Co., Ltd., one of the co-applicants of this application, has already suggested a surface light source apparatus having a local dimming function using one or more point-like light sources (see: Patent Literature 4). This already suggested surface light source apparatus is now explained by using FIGS. 16, 17 and 18.

FIG. 16 is a perspective view illustrating the already-suggested surface light source apparatus.

In FIG. 16, there are 2×4 tandem-arranged light guide plates 411, 412, 413, 414, 421, 422, 423 and 424 which are optically separated from each other, at a post stage of an initial-stage reflective plate 400. In FIG. 16, note that an optical sheet formed by a diffusion plate 6 (see: FIG. 17), a diffusion film, a prism sheet and a reflective polarizer plate (not shown) is provided on the initial-stage reflective plate 400 and the light guide plates 411, 412, 413, 114, 421, 422, 423 and 424.

FIG. 17 is a cross-sectional view of the surface light source apparatus of FIG. 16.

As illustrated in FIG. 17, provided within a housing 1 is an LED mounting substrate 12, and LEDs 311, 312, 313 and 314 are mounted on the LED mounting substrate 4 as primary light, sources. Note that each of the LEDs 311, 312, 313 and 314 illustrates one or more LEDs representatively. The initial-stage reflective plate 400 and the light guide plates 411, 412, 413 and 411 are superposed onto each other, and reflective films 511, 512, 513, 514 and 515 are inserted therebetween so that leakage light, which cannot be guided at a pre-stage light guide plate is reflected by the pre-stage light guide plate without being incident, to a post stage light guide plate.

Each of the LEDs 311, 312, 313 and 314 is mounted in LED accommodating regions 711, 712, 713 and 714 to face the incident edge of the light guide plates 411, 412, 413 and 414.

FIG. 18 is a perspective view or the light guide plate such as 411 of FIG. 16.

As illustrated in FIG. 18, the light guide plate such as 411 has a light incident edge face T1 for receiving light emitted from a plurality of LEDs, an opposite light incident edge face T2, a planar face T3, a sloped face T4, a light emitting face T5, a side face 16, a side face 47 and a bottom face T8. The planar face T3, the sloped face 44, a part of the side face T6 and a part of the side face 47 form a color-mixing region R1, and the light emitting face 45, the remainder of the side face 46 and the remainder of the side face T7 form an available region R2.

The color-mixing region R1 of the light guide plate 111 is provided in order to availablely color-mix lights of monochromatic light LEDs provided at the light incident edge face T1, for example, to obtain white light and/or in order to avoid the brightness iron-uniformity, i.e., homogenize the brightness. On the other hand, the available region R2 of the light guide plate 411 is provided for emitting illumination light from the light emitting face 15.

Returning to FIG. 17, the available region R2 of the light guide plate such as 411 is provided to be superposed onto the color-mixing region R1 of the next-stage light guide plate 412, thus constituting a uniform luminance of surface light sources of the surface light source apparatus. Also, the light emitted from the available region R2 of one light guide plate is diffused and reflected by optical sheets formed by the diffusion plate 6 and the like, so that the brightness non-uniformity is suppressed by a so-called light, recycle effect.

### PRECEDING TECHNICAL LITERATURES

### Patent Literatures

Patent Literature 1: Japanese Unexamined Utility Model Publication No. Sho 63-21906
Patent Literature 2: Japanese Unexamined Patent Publication No. Hei 11-288611
Patent Literature 3: Japanese Unexamined Patent Publication No. 2002-72204
Patent Literature 4: Japanese Patent Application No. 2008-063181 (Japanese Unexamined Patent Publication No. 2009-218175)

### SUMMARY OF THE INVENTION

### Problem to be Solved by the Invention

In the above-described already-suggested surface light source apparatus, however, since the available region R2 of one light guide plate is completely superposed onto the color-mixing region R1 of the next-stage light guide plate, when an LED or a color-mixing region R1 at a voluntary position is needed to be repaired, all the superposed elements have to be removed. For example, if the LED 314 or the light guide plate 414 needs to be repaired, all the light guide plates 411 to 413 have to be removed. As a result, the number of assembling steps during a repairing mode is increased to increase the manufacturing cost, which is a problem.

Also, generally, most of the loss of energy inputted to an LED as a backlight light source is converted to heat. Particularly, in a display unit such as a liquid crystal television set for displaying motion pictures or in a display unit which is expected to be used outdoors under the direct rays of the sun, high brightness is required to increase the LED driving current associated with the increase of the loss and self-exothermic effect. Therefore, in order to maintain a backlight light source even at an expected high temperature in a driving mode, an air gap in consideration of expected thermal expansion/compression needs to be provided between the elements, i.e., between the light guide plates 411 to 414 and the light guide plates 421 to 424.

For example, if a housing 1 for a 65-type backlight (size of 1439.2 mm×812 mm) is made of aluminum, the ambient temperature in an operation mode is −10 to 60° C., the room temperature is 25° C., and the linear expansion coefficient is 2.35×10⁻⁵/° C., then the expansion and compression width of the housing 1 at an ambient temperature range is 2.4 mm in the horizontal direction and 1.4 mm in the vertical direction. Therefore, if the air gap between the 11 ht guide plates 411 to 414 and the light guide plates 421 to 424 which are adjacent to each other is 0 at the maximum temperature 60° C., the air gap G between the above adjacent light guide plates 411 to 414 and the light guide plates 421 to 424 is 2.4 mm at the minimum temperature −10° C. Actually, if the expansion/compression of the light guide plates and the assembling error of each element is considered, the air gap G between the light guide plates exceeds 2.4 mm. As a result, the quality of backlights is reduced.

FIG. 19 is a graph showing the result of the simulation of the illumination distribution S between the light, guide plates of FIG. 16.

As illustrated in FIG. 19, when the air gap 6 between the light guide plates is about 0.5 mm, the dark portions where the brightness is low are generated on the backlight, and when the air gap 0 between the light guide plates is much larger, the dark portions become larger.

Therefore, if the air gap G between the light guide plates is 2.4 mm, the dark portions are larger to increase the brightness non-uniformity, which is another problem.

Note that, in order to homogenize the brightness non-uniformity due to the air gap G between the light guide plates, some optical elements have to be added; in this case, the efficiency of backlights is reduced and the manufacturing cost is increased.

Further, since the number of light-adjusting areas coincides with that of light guide plates, when the number of light-adjusting areas is increased, the number of light guide plates is increased. For example, in a liquid crystal television set, if the number of light-adjusting areas is 48×24=1152, the number of light guide plates is 1152. That is, the total number of components is increased. As a result, as compared with a backlight using one large size light guide plate, the number of assembling steps is increased to increase the manufacturing cost, which is a problem.

### Means for Solving the Problems

In order to solve the above-mentioned problems, a surface light, source apparatus having a plurality of light-adjusting areas comprises at least one primary light source allocated for each of the light-adjusting areas; a plurality of color-mixing elements, each of the color mixing elements allocated to one of the light-adjusting areas, for guiding primary light from the primary light source allocated to each of the color-mixing elements to color-mix the primary light or homogenize the brightness; and available elements, allocated to at least two of the light-adjusting areas, for receiving secondary light from the at least two of the color-mixing elements allocated by the at least two of the light-adjusting areas to emit the secondary light, thus constituting a non-superposing structure where voluntarily-selected primary light source and color-mixing element can be removed without removing the other light source and color-mixing element. The non-superposing structure is a structure where each primary light, source and each color-mixing element have a relationship where they are not superposed onto each other or a relationship where, even if they are slightly superposed onto each other, they are sloped to easily assemble or remove them. Therefore, when one primary light source or one color-mixing element is repaired, one available element on this primary light source or color mixing element has only to be removed. Also, there is little air gap between light guide plates in the available element which air gap was present in the already-suggested surface tight source apparatus.

The number of the available elements is one, so that the light-adjusting areas are entirely covered by one available element. Titus, when any primary light source or color-mixing element, is repaired, this available element has only to be removed. Also, there is no air gap between light guide plates in the available element which air gap was present in the already-suggested surface light source apparatus.

Each of the color-mixing elements may be a highly reflective film surrounding space, defining the space from the primary light source to a light incident edge face of the available elements. The highly reflective film may be a metal film such as silver or aluminum deposited on a resin base such as polyethylene terephthalate (PET), or a highly reflective resin film such as microcellular FET.

Also, each of the color-mixing elements has a light incident edge face for receiving primary light from the primary light source, has an upper face, side faces and a bottom face for color-mixing an incident light from the light incident, edge face, and has an opposite light incident edge face as a tight emitting face for emitting the color-mixed light. On the other hand, the available element has a plurality of light incident edge faces for receiving secondary light from each of the color-mixing elements, a light emitting face, and a plurality of reflective faces opposing the light emitting face in contact with each of the color-mixing elements.

Further, two or more light-adjusting areas are integrated by one color-mixing element, to constitute a so-called chain-connected color-mixing element. Thus, the number of components is reduced.

### Effect of the Invention

According to the present invention, during a repairing mode, since a corresponding or one available element has only to be removed, the number of assembling steps during a repairing mode is reduced, so that the manufacturing cost can be decreased. Further, since there is hardly or completely no air gap between the light guide plates which was present in the already-suggested surface light source apparatus, there is no darkness where the brightness is low and therefore, there is non-uniformity of brightness, so that the quality of backlights can be improved. Further, since the total number of components is reduced, the manufacturing cost can be decreased.

### BRIEF DESCRIPTION OF THE DRAWINGS

FIG. 1 A perspective view illustrating a first embodiment of the surface light source apparatus according to the present invention.

FIG. 2 Across sectional view of the surface light source apparatus of FIG. 1.

FIG. 3 A perspective view illustrating the color-mixing section of FIG. 1 in detail.

FIG. 4 A perspective view illustrating the color-mixing element of FIG. 3 in detail.

FIG. 5 A perspective view illustrating the available element of FIG. 1 in detail.

FIG. 6 A perspective view illustrating a modification of the color-mixing section of FIG. 1.

FIG. 7 A cross-sectional view of FIG. 6.

FIG. 8 A perspective view illustrating a modification of the color-mixing element of FIG. 4.

FIG. 9 A perspective view illustrating a modification of the available element of FIG. 1.

FIG. 10 A cross-sectional view of FIG. 9.

FIG. 11 A perspective view illustrating another modification of the available element, of FIG. 1.

FIG. 12 A cross-sectional view of FIG. 11.

FIG. 13 A cross-sectional view illustrating a second embodiment of the surface light source apparatus according to the present invention.

FIG. 14 A side view of FIG. 13 where the available element is removed.

FIG. 15 A diagram for explaining the chain-connection of the color-mixing elements of FIG. 13.

FIG. 16 A perspective view illustrating an already-suggested surface light source apparatus.

FIG. 17 A cross-sectional view of the surface light source apparatus of FIG. 16.

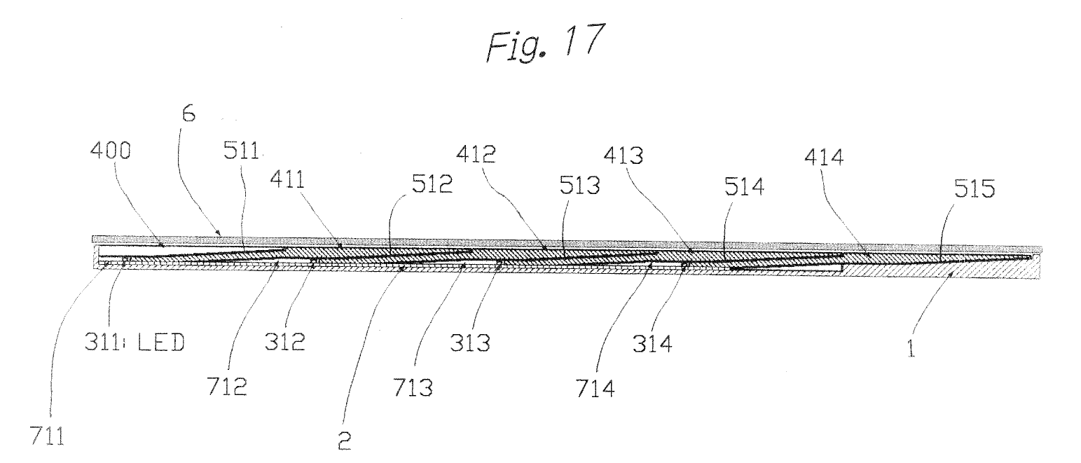

FIG. 18 A perspective view of the light guide plate of FIG. 16.

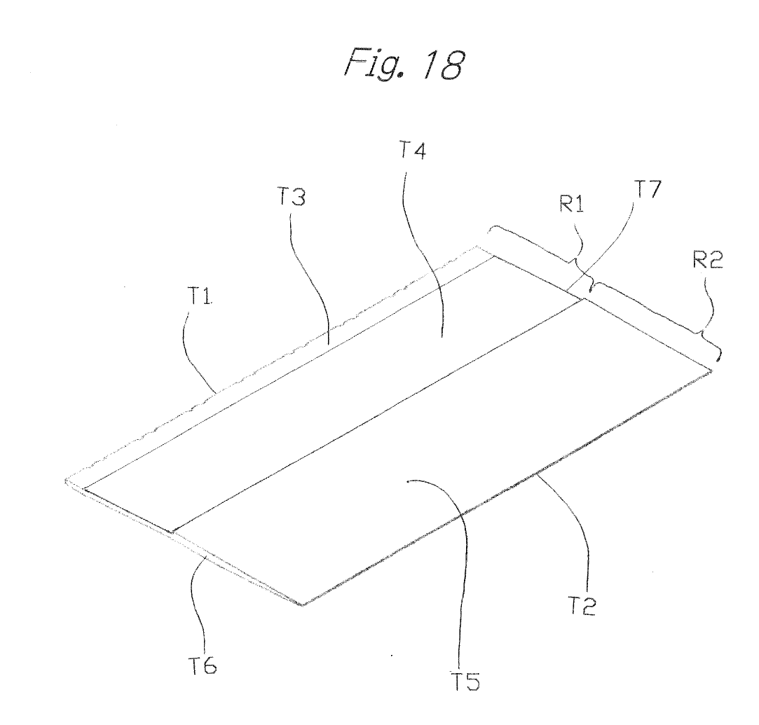

FIG. 19 A graph for explaining the gap between the light guide plates for explaining the problems of the surface light source apparatus of FIG. 16.

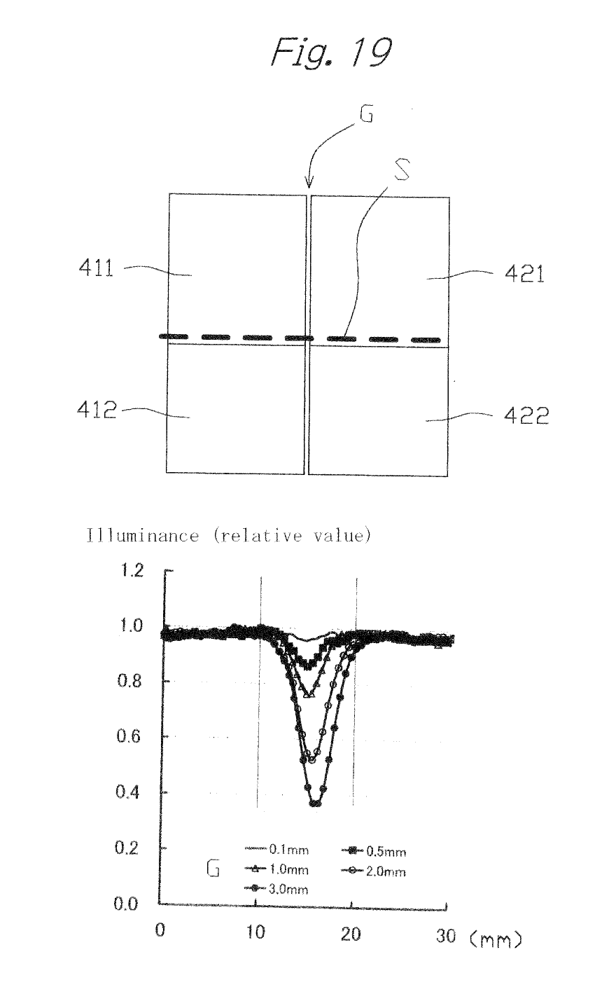

### MODE FOR CARRYING OUT THE INVENTION

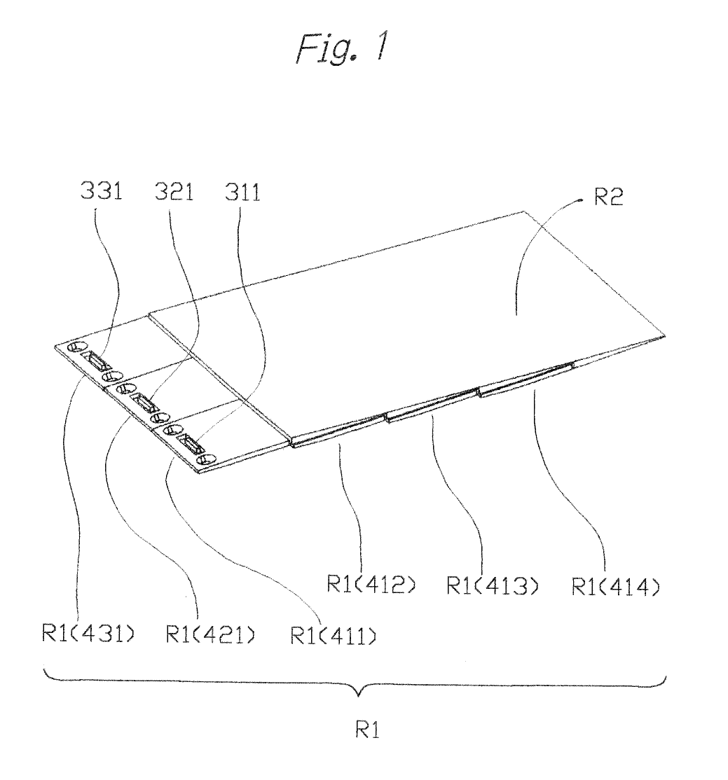

FIG. 1 is a perspective view illustrating a first embodiment of the surface light source apparatus according to the present invention.

As illustrated in FIG. 1, a surface light source apparatus is constructed by a 3×4 partitioned tandem light, guide elements. That is, the surface tight source apparatus is constructed by LEDs 311, 312, 313, 314, 321, 322, 323, 324, 331, 332, 333 and 334 (only 311, 321 and 331 are shown) as primary light sources, one or more primary light sources for supplying primary light, to each partition, i.e., to each light-adjusting area, and a color-mixing section R1 for receiving the primary light from each of the LEDs 311, 312, 313, 314, 321, 322, 323, 324, 331, 332, 333 and 334 to homogenize or color-mix the primary light, and an available element R2 for uniformly emitting secondary light from the color-mixing section R1 from the light emitting face.

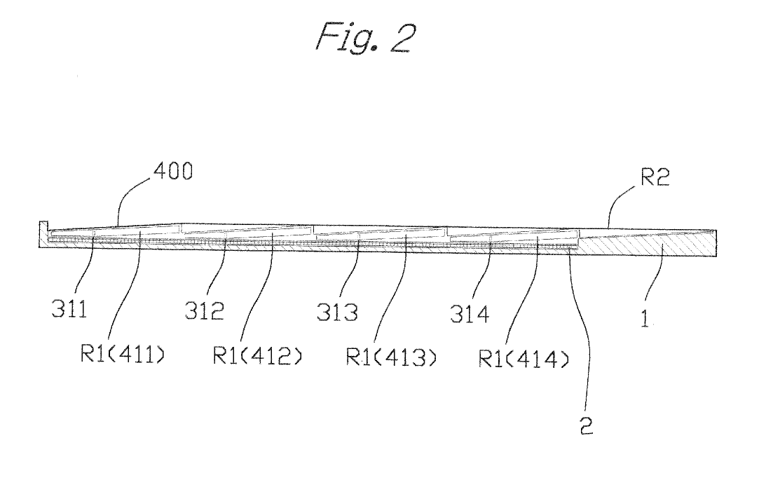

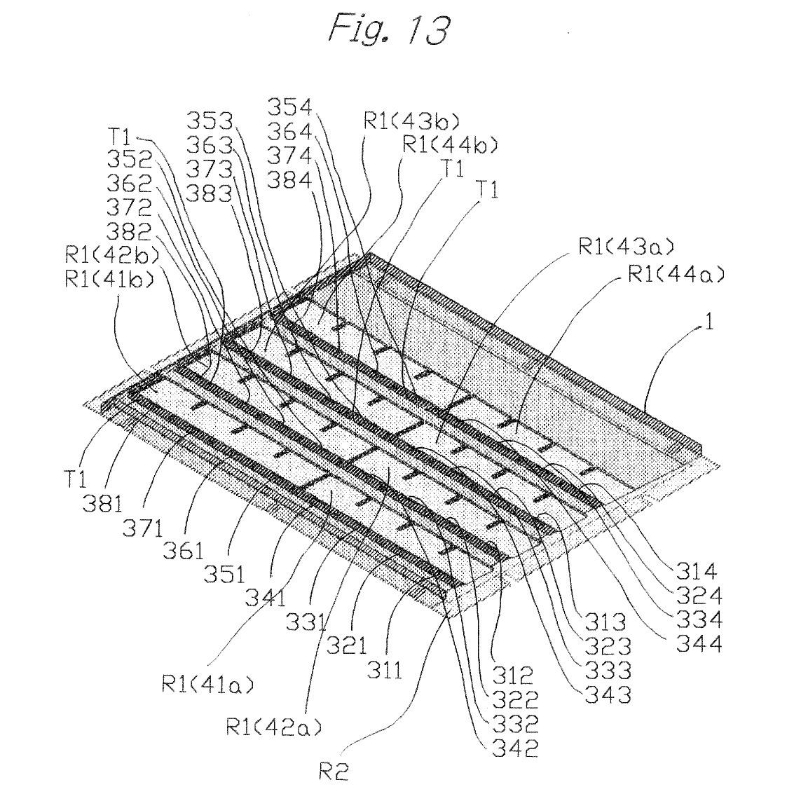

FIG. 2 is across-sectional view of the surface light source apparatus of FIG. 1. As illustrated in FIG. 2, in the same way as in FIG. 13, the initial-stage reflective plate 400 is provided. Provided within the housing 1 is an LED mounting substrate 2 on which the LEDs 311, 312, 313, 314, 321, 322, 323, 324, 331, 332, 333 and 331 are mounted.

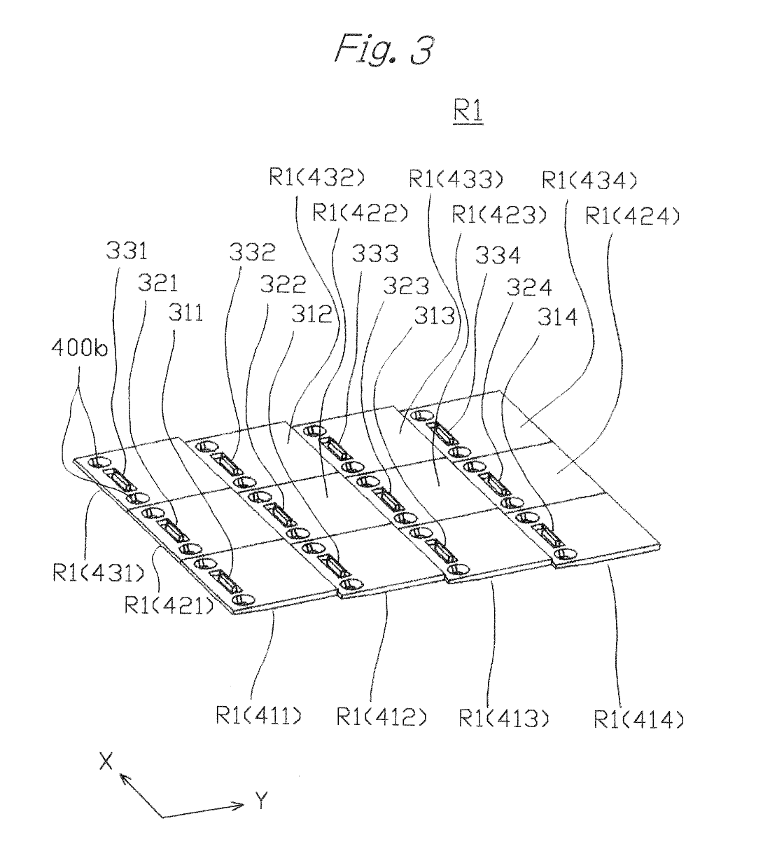

FIG. 3 is a perspective view illustrating the color-mixing section R1 of FIG. 1 in detail.

As illustrated in FIG. 3, the color-mixing section R1 has optically independently provided color-mixing elements R1(411), R1(412), R1(413), R1(414), R1(421), R1(422), R1(423), R1(424), R1(431), R1(432), R1(433) and R1(434). It should be noted that the color-mixing elements R1(411), R1(412), . . . , R1(134) are not superposed onto each other. “The color-mixing elements are not superposed onto each other” means that the color-mixing elements have a relationship where they are not superposed onto each other or a relationship where, even if the color-mixing elements are slightly superposed onto each other, the color-mixing section R1 is sloped to easily assemble or remove the color-mixing elements.

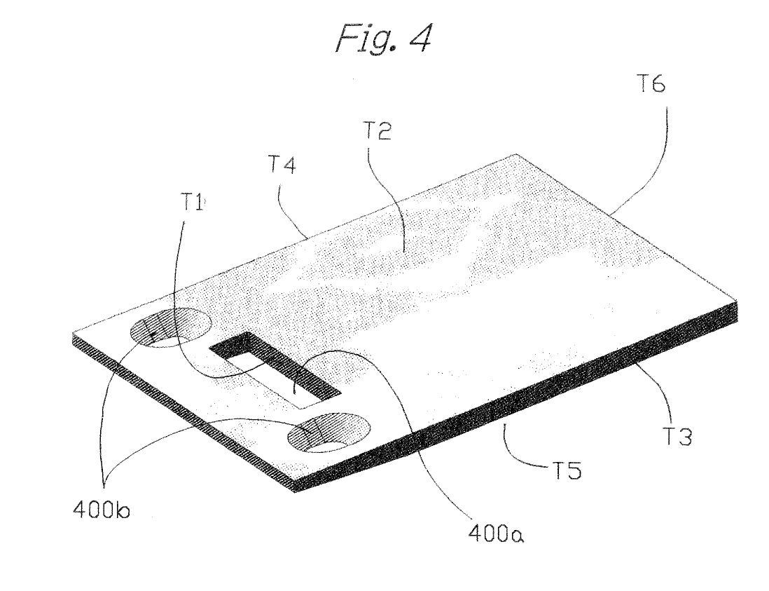

FIG. 4 is a perspective view illustrating one of the color-mixing elements of FIG. 3 in detail.

As illustrated in FIG. 4, the color-mixing element such as R(411) has a light incident edge face T1 for receiving primary light of the LEDs, has an upper face T2, side faces T3 and T4 and a bottom face T5 for color-mixing incident light from the light incident edge face T1, and has a light emitting face (opposite light incident edge face) T6. Also, a cutout 400a accommodating an LED and screw holes 400b for fixing the color-mixing element to the LED mounting substrate 2 (see: FIG. 2) are provided. Protrusions may be provided instead of the screw holes 400b.

In any face of the color-mixing elements of FIG. 4, diffusion control elements may be provided, as occasion demands. Here, the diffusion control elements are knurling tools, prisms, micro dot objects such as multi-facial bodies or rotational secondary paraboloids, or stripe print or dot print which is printed by using highly reflective coating material whose printing area is controlled.

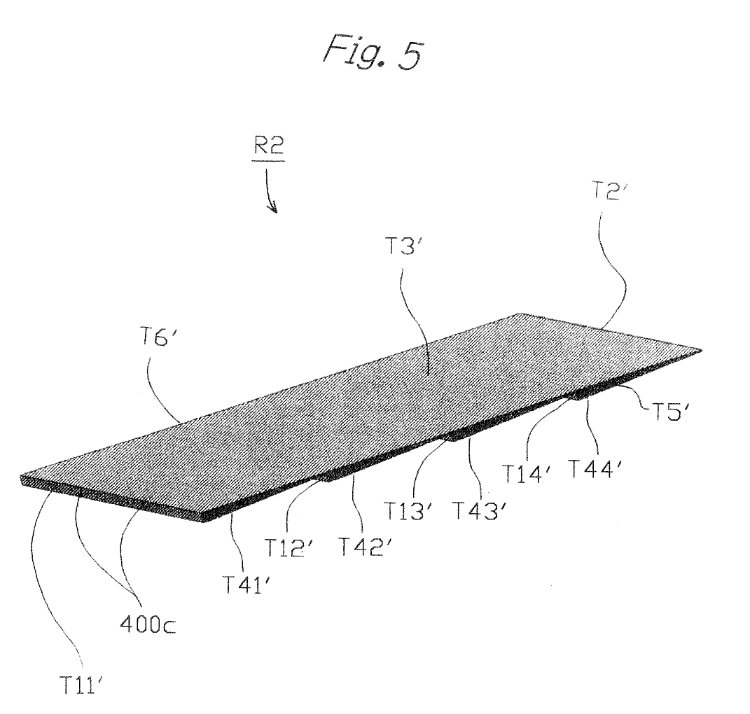

FIG. 5 is a perspective view of the available element R2 of FIG. 1 in detail.

As illustrated in FIG. 5, the available element R2 has a light incident edge faces T11′, T12′, T13′ and T14′ for receiving secondary light from the color-mixing section R1, an opposing light incident edge face T2′, a light emitting face T3′, opposing light emitting faces T41′, T42′, T43′ and T44′ and side faces T5′ and T6′. Also, opposing light, emitting faces T41′, T42′, T43′ and T44′ are in contact with the color-mixing elements. Further, notches 400c are provided at boundaries of light-adjusting areas to limit leakage light from adjacent light-adjusting areas.

As illustrated in FIG. 2, the binding between the color-mixing elements and the available element RP is carried out so that secondary light from the light emitting face T6 of the color-mixing elements is incident, to the light receiving face such as T11′ of the available element R2. In view of the binding efficiency, it is preferable that the height (or width) of the light incident edge face T11′ of the available element R2 is the same as (or larger than) the light emitting face T6 of the color-mixing elements. Particularly, if the binding efficiency is not considered, the secondary light from the color-mixing elements may only be incident, to the light incident edge face such as T11′ of the available element R2.

Provided at the light emitting face T3′ and the opposing light emitting faces T41′, T42′, T43′ and T44′ of the available element R2 are brightness control elements. Here, the brightness control elements are knurling tools, prisms, micro dot objects such as multi-facial bodies or rotational secondary paraboloids, or stripe print or dot print which is printed by using highly reflective coating material whose printing area is controlled.

Also, the color-mixing element of FIG. 4 and the available element R2 of FIG. 5 are formed by performing a cutting process, a pressing process, or a molding process such as an injection-molding process, a cast-molding process or an extrusion-molding process upon polymethylmethacrylate (PMMA), polycarbonate (PC), cycloolefin resin or glass.

According to the above-described first embodiment, if the size of the local-dimming light-adjusting areas in the Y direction is larger than the size of the color-mixing elements R1(411) and the like as in FIG. 3, there is no superposing portions between the primary light source LED 311 and the color-mixing element. R1(411), between the primary light source LED 312 and the color-mixing element R1(412), and the like. Here, “the LED and the color-mixing elements are not superposed” means that the LED and the color mixing elements have a relationship where they are not superposed onto each other or a relationship where, even if the LED and the color-mixing element are slightly superposed onto each other, the LED and the color-mixing section are sloped to easily assemble or remove the LED and the color-mixing element. Therefore, when the LED 311 or the like or the color-mixing element R1(411) or the like is repaired, one available element R2 has only to be removed. As a result, the number of assembling steps in a repairing mode is reduced to decrease the manufacturing cost.

Also, according to the above-described first embodiment, since one available element R2 as illustrated in FIG. 5 is allocated to a plurality of color-mixing elements R1(411) and the like, the available element R2 in the X direction is seamless. Therefore, even when there is an air gap between the color-mixing element R1(411) and the like in the X direction, the quality of a backlight can be improved.

In the above-described first embodiment, in order to improve the brightness non-uniformity and the brightness, an optical sheet such as a diffusion plate, a prism sheet or a reflective polarizer plate can be mounted on the available element R2 of the light guide plate. Also, in order to improve the light emission efficiency, reflective films can be provided above and under the color-mixing elements R1(411) and the like of the color-mixing section R1 and under the available section R2.

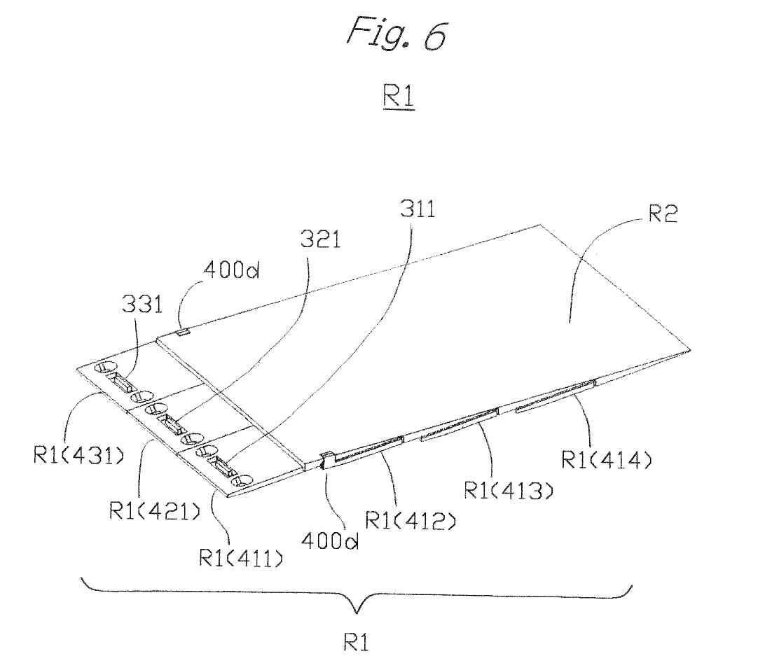

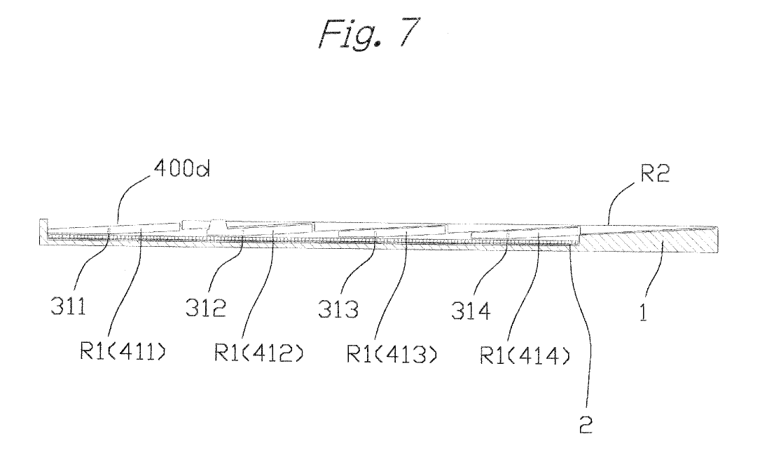

FIG. 6 is a perspective view of a modification of the color-mixing section R1 of FIG. 1, and FIG. 7 is a cross-sectional view of FIG. 6.

As illustrated in FIGS. 3 and 7, a hook 400d for holding and fixing the available element R2 is provided at a part of the color-mixing elements such as R1(412) or R1(432) of the color-mixing section Note that, a protrusion or a pin can be provided instead of the hook 400d. Thus, the available element R2 can surely be held and fixed.

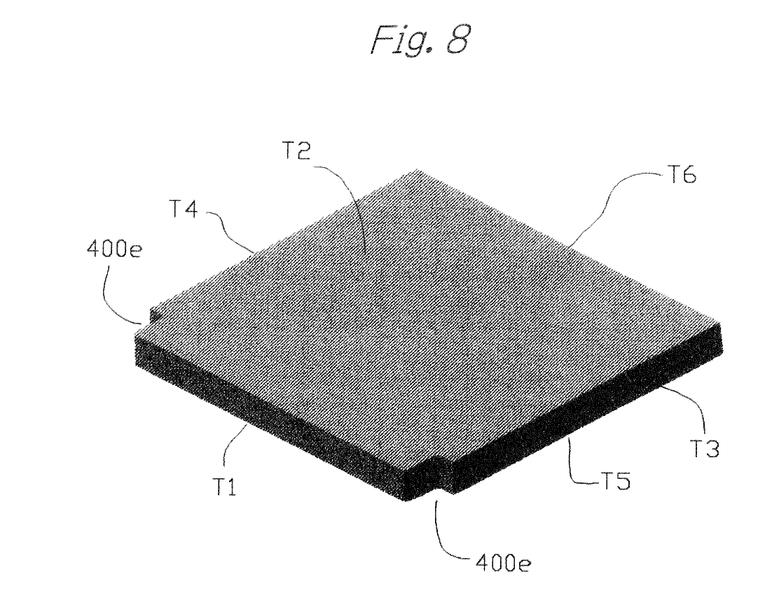

FIG. 8 is a modification of the color-mixing element of FIG. 4.

As illustrated in FIG. 8, the light incident edge face T1 can be outside of a multi facial body. In this case, an cutout 400e is provided instead of the screw hole 400b.

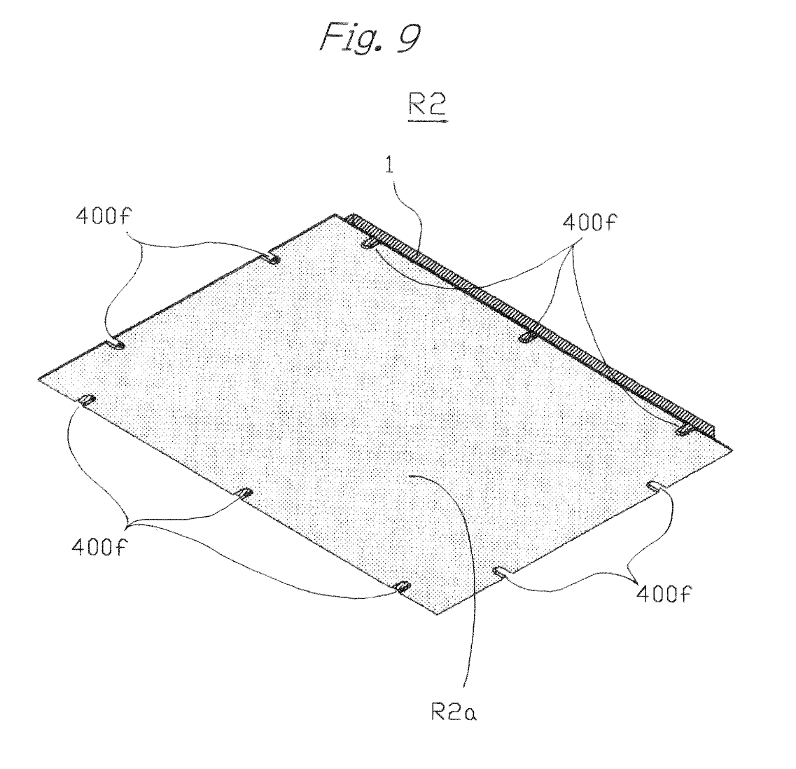

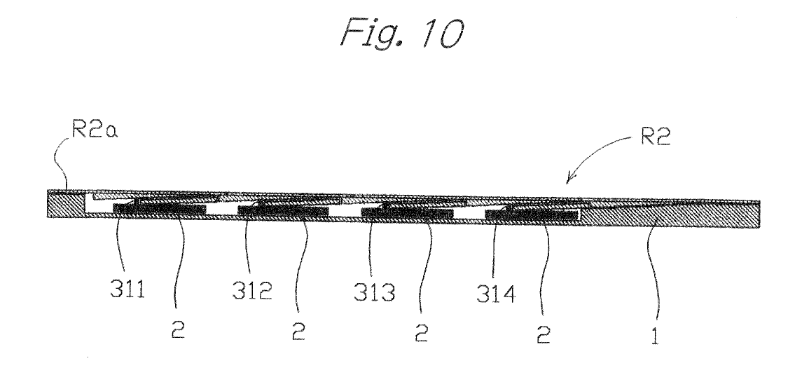

FIG. 9 is a perspective view illustrating a modification of the available element R2 of FIG. 1, and FIG. 10 is a perspective view where the available element. R2 of FIG. 9 is incorporated into a surface light source apparatus.

As illustrated in FIGS. 9 and 10, the available element. R2 may be broader than an illumination region, and an external edge portion, i.e., a frame R2a may be provided at the light emitting face T3′. The material of the frame R2a is the same as that of the available element R2. A cutout 400f for holding and fixing the available element R2 to the housing 1 is provided at the frame R2a. Note that a screw hole or a protrusion may be provided instead of the cutout 400f.

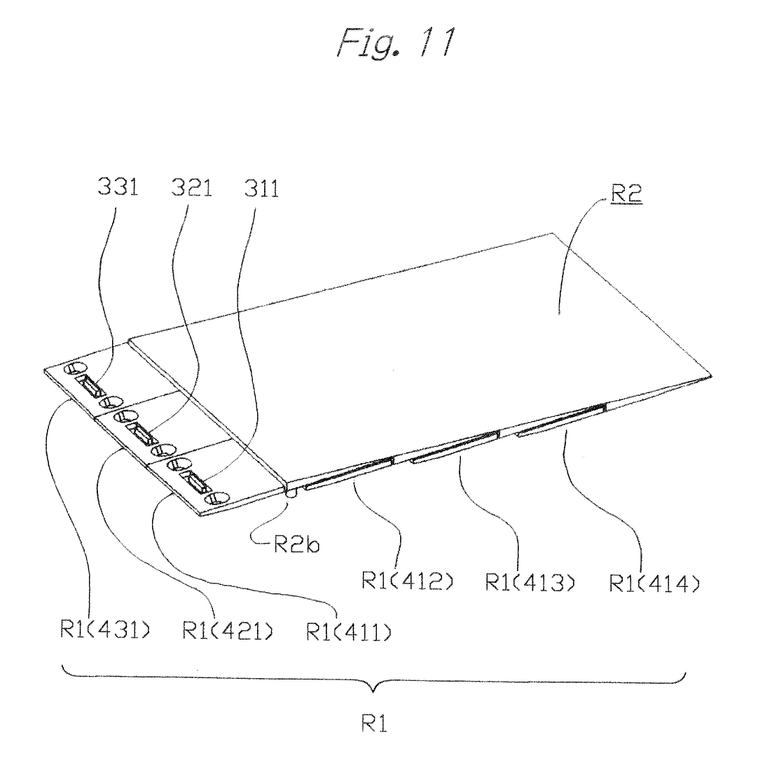

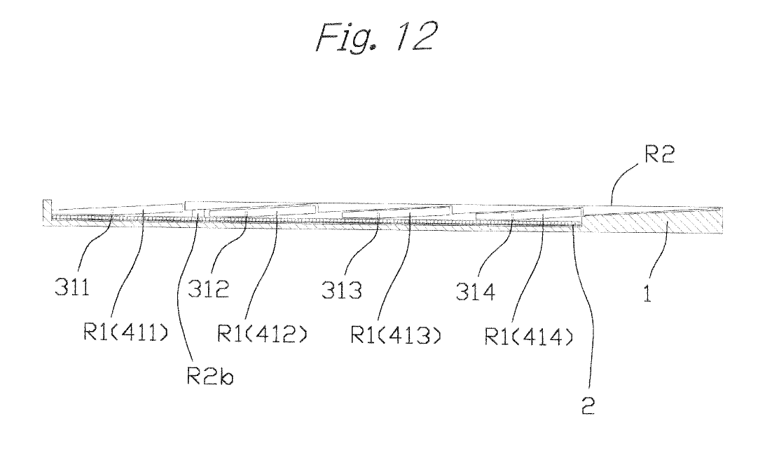

FIG. 11 is a perspective view illustrating another modification of the available element R2 of FIG. 1, and FIG. 12 is a cross-sectional view of FIG. 11.

As illustrated in FIGS. 11 and 12, a pin R2b for holding and fixing the available element. R2 to the housing 1 is provided. Thus, the available element R2 is surely held and fixed to the housing 1. Note that a protrusion or a hook may be provided instead of the pin. R2b.

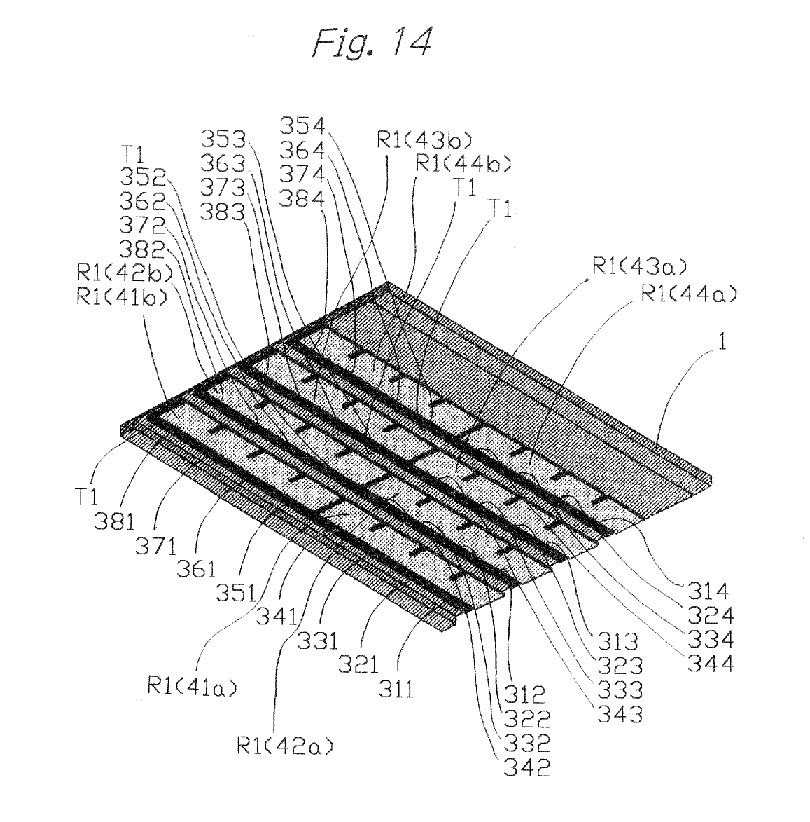

FIG. 13 is a cross-sectional view illustrating a second embodiment of the surface light source apparatus according to the present invention, and FIG. 14 is a side view of FIG. 13 where the available element R2 is removed from FIG. 13.

As illustrated in FIGS. 13 and 14, each color-mixing element R1(41a), R1(42a), R1(43a), R1(44a), R1(41b), R1(42b), R1(43b) or R1(44b) is constructed by four color-mixing elements of FIG. 1. That is, the color-mixing elements are four-chain-connected. Thus, the number of components of the color-mixing elements is reduced to ¼, and therefore, the manufacturing cost can be reduced.

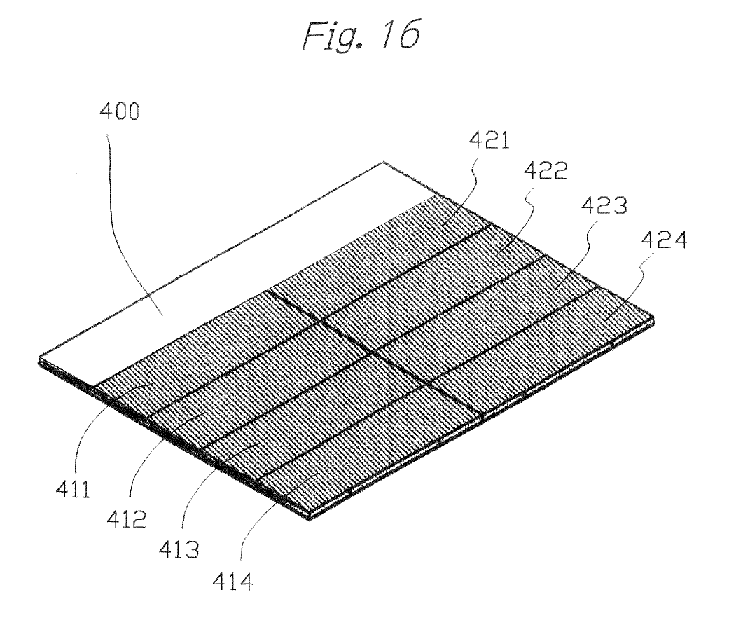

For example, when the number of light-adjusting areas of an 8×4 tandem arrangement is 24, the number of components of the already-suggested surface light source apparatus of FIG. 16 are as follows:

| | |
|---|---|
| light guide plates | 32 |
| primary light sources | 32 |
| total number of components | 64 |

On the other hand, the number of components of the surface light source apparatus of FIG. 1 are as follows:

| | |
|---|---|
| color-mixing elements | 32 |
| avaliable elements | 1 |
| primary light sources | 32 |
| total number of components | 65 |

The number of components of the surface light source apparatus of FIG. 13 are as follows:

| | |
|---|---|
| color-mixing elements | 8 |
| available element | 1 |
| primary light sources | 32 |
| total number of components | 41 |

Therefore, the total number of components of the second embodiment of the present invention can be remarkably reduced, so that the manufacturing cost of the surface light source apparatus can be reduced.

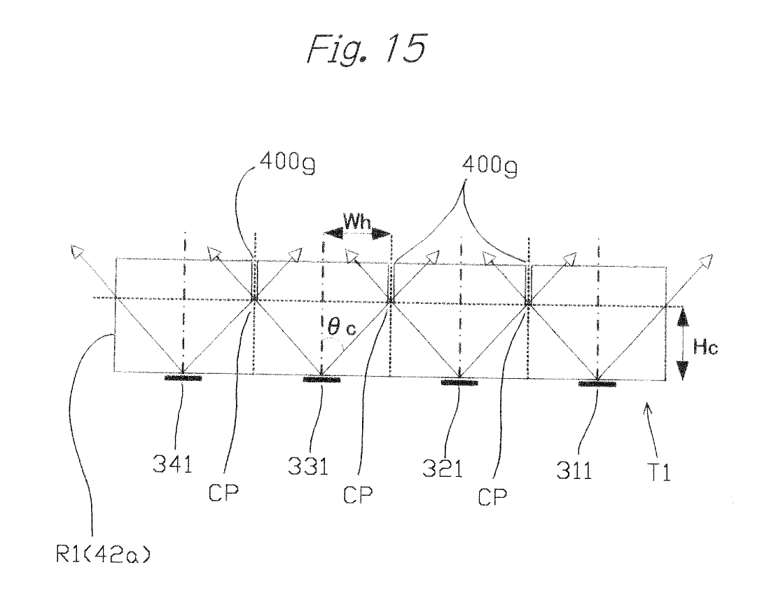

FIG. 15 is a diagram for explaining the length of a slim notch 400g of the four-chain-connected color-mixing element such as R1(42a) of FIG. 13.

As illustrated in FIG. 15, the slim notch 400g is provided at the boundaries of the light-adjusting areas to limit leakage light from their adjacent light-adjusting areas. If the LEDs 311, 321, 331 and 341 are approximated to be point-like light sources, the directivity characteristics of incident light from each of the LEDs 311, 321, 331 and 341 to the four-consecutive color-mixing elements R1(42a) become narrow. That is, when color-mixing elements are consecutive, the color-mixing elements are bonded at regions where the incident light rays do not interfere with each other, the regions being determined by a distance 11, from the light incident edge face T1 to the slim notch 400g. If the light incident angle of the incident light rays is θ_{C}, the distance H_{C} is given by:

θ_{C}=sin⁻¹(1/n)

H_{C}≦Wₕ tan θ_{C}

≦Wₕ tan(sin⁻¹/n))

where 2Wₕ is a width of the tight-adjusting areas.

In FIG. 13, the available element R2 is the same as the available element R2 of FIG. 9, the available element R2 can be the other available element R2 of FIG. 1 or 11, for example. Also, the modifications of FIGS. 6 to 12 can be applied to the above-described second embodiment.

Also, in the above-described second embodiments, linear light sources such as cold cathode fluorescent lamps and hot cathode fluorescent lamps can be used in addition to point-like light, sources such as LEDs, and also, a combination of point-like light sources and linear light sources can be used.

Further, in the above described first and second embodiments, one available element R2 of light guide plates is provided for the entire light-adjusting area however, one available element R2 may be provided for a plurality of light-adjusting areas.

### DESCRIPTION OF THE SYMBOLS

1: housing
2: LED mounting substrate
311, 312, 313, 311: LEDs
400: initial-stage reflective plate
400a: LED accommodating cutout
400b: screw hole
400c: notch
400d: hook
400e: cutout
400f: cutout
400g: slim notch
411, 412, 413, 414, 421, 422, 423, 424: light guide plates
511, 512, 513, 514, 515: reflective films
6: diffusion plate
711, 712, 713, 714: LED accommodating regions
R1: color-mixing region (color-mixing section)
R1(411), R1(412), . . . , R1(434): color-mixing elements
R1(41a), R1(42a), R1(43a), R1(44a), R1(41b), R1(42b), R1(43b), R1(44b): four-consecutive color-mixing elements
R2: available region (available element)
R2a: frame
R2b: pin

1. A surface light source apparatus having a plurality of light-adjusting areas, comprising:
at least one primary light source allocated for each of said light-adjusting areas;
a plurality of color-mixing elements, each of said color-mixing elements allocated to one of said light-adjusting areas, for guiding primary light from said primary light source allocated to said each of said color-mixing elements to color-mix said primary light or homogenize the brightness; and
at least one available element, allocated to at least two of said light-adjusting areas, for receiving secondary light from said at least two of said color-mixing elements allocated by said at least two of said light-adjusting areas to emit said secondary light,
thus constituting a non-superposing structure where a voluntarily-selected primary light source and a color-mixing element can be removed without removing other light source elements and color-mixing elements.

2. The surface light source apparatus as set forth in claim 1, wherein said at least one available element comprises one available element, said light-adjusting areas being entirely covered by said one available element.

3. The surface light source apparatus as set forth in claim 1, wherein said color-mixing elements are made of light-transparent resin material.

4. The surface light source apparatus as set forth in claim 1, wherein said color-mixing elements comprise highly reflective films surrounding a space, said space defining from said primary light source to a light incident edge of said at least one available element.

5. The surface light source apparatus as set forth in claim 1, wherein each of said color-mixing elements has a light incident edge face for receiving primary light from said primary light source, an upper face, side faces, and a bottom face for color-mixing incident light from said light incident edge face, and an opposite light incident edge face as a light emitting face for emitting said color-mixed light.

6. The surface light source apparatus as set forth in claim 5, wherein said light incident edge face is provided at a cutout for accommodating said primary light source within said color-mixing elements.

7. The surface light source apparatus as set forth in claim 6, further comprising a mounting substrate for mounting said primary light source, a screw hole being provided at each of said color-mixing elements to fix said each of said color-mixing elements to said mounting substrate.

8. The surface light source apparatus as set forth in claim 6, further comprising a mounting substrate for mounting said primary light source, a protrusion being provided at each of said color-mixing elements to fix said each of said color-mixing elements to said mounting substrate.

9. The surface light source apparatus as set forth in claim 5, wherein said light incident edge face is provided outside of each of said color-mixing elements.

10. The surface light source apparatus as set forth in claim 9, further comprising a mounting substrate for mounting said primary light source,
a cutout being provided at each of said color-mixing elements to fix said each of said color-mixing elements to said mounting substrate.

11. The surface light source apparatus as set forth in claim 1, wherein said at least one available element has a plurality of light incident edge faces for receiving secondary light from each of said color-mixing elements, a light emitting face, and a plurality of reflective faces opposing said light emitting face in contact with each of said color-mixing elements.

12. The surface light source apparatus as set forth in claim 1, wherein notches are provided at positions of said at least one available element corresponding to boundaries of each of said light-adjusting areas so as to limit leakage light from their adjacent light-adjusting areas.

13. The surface light source apparatus as set forth in claim 1, wherein one of a hook, a protrusion, and a pin is provided for at least part of said color-mixing elements so as to hold and fix said available element.

14. The surface light source apparatus as set forth in claim 1, further comprising a frame at an external edge portion of a light emitting face of said at least one available element.

15. The surface light source apparatus as set forth in claim 14, wherein one of a cutout, a screw hole, and a protrusion is provided so as to hold and fix said frame to a housing of said surface light source apparatus.

16. The surface light source apparatus as set forth in claim 1, wherein one of a pin and a hook is provided for said at least one available element to fix said at least one available element to a housing of said surface light source apparatus.

17. The surface light source apparatus as set forth in claim 1, wherein a plurality of said color-mixing elements are chain-connected to constitute a chain-connected color-mixing element.

18. The surface light source apparatus as set forth in claim 17, wherein slim notches are provided at boundaries of said light-adjusting areas of said consecutive color-mixing element to limit leakage light from their adjacent light-adjusting areas.

19. The surface light source apparatus as set forth in claim 18, wherein said color-mixing elements in said chain-connected color-mixing element are connected within a distance H, from a light incident edge face of said consecutive color-mixing element at boundaries of said light-adjusting areas of said consecutive color-mixing elements, the distance H_{C} being given by:
H_{C}=Wₕ tan(sin⁻¹(1/n))
where 2Wₕ is a width of said light-adjusting areas, and n is a refractive index of said color-mixing elements.
